(19) United States
(12) Patent Application Publication
(10) Pub. No.: US 2024/0267088 A1
(43) Pub. Date: Aug. 8, 2024

(54) METHOD FOR REFLECTIVE INDEX MODULATION BASED ON INTELLIGENT REFLECTING SURFACE

(71) Applicant: UNIVERSITY OF ELECTRONIC SCIENCE AND TECHNOLOGY OF CHINA, Chengdu (CN)

(72) Inventors: Kun YANG, Chengdu (CN); Yizhe Zhao, Chengdu (CN); Long Zhang, Chengdu (CN); Jie Hu, Chengdu (CN)

(73) Assignee: UNIVERSITY OF ELECTRONIC SCIENCE AND TECHNOLOGY OF CHINA, Chengdu (CN)

(21) Appl. No.: 18/634,170

(22) Filed: Apr. 12, 2024

(30) Foreign Application Priority Data
Apr. 21, 2023 (CN) 202310438362.8

(51) Int. Cl. H04B 7/04; H04L 27/36

(52) U.S. Cl. CPC H04B 7/04013; H04L 27/36

(57) ABSTRACT

A method for reflective index modulation based on intelligent reflecting surface, in which an IRS control unit is added into wireless communication system, and the data to be transmitted in a transmission is divided into two parts: a reflective domain data dᵣ and a phase-amplitude domain data d_{c}, the reflective domain data dᵣ is transmitted through a wired connection to the IRS control unit to activate or deactivate each group of reflecting elements, the phase-amplitude domain data d_{c} is modulated through traditional phase-amplitude domain modulation and transmitted to the IRS, the reflected signals contain the information of the reflective domain data dᵣ, through the demodulating the baseband symbol y_{m,j}, an estimated phase-amplitude modulation index m and an estimated reflective index j̅ are obtained to recover the phase-amplitude domain data d_{c} and the value of the reflective domain data dᵣ respectively.

### FIELD OF THE INVENTION

This application claims priorities under the Paris Convention to Chinese Patent Application No. 202310438362.8, filed on Apr. 21, 2023, the entirety of which is hereby incorporated by reference for all purposes as if fully set forth herein.

The present invention relates to the field of wireless modulation, more particularly to a method for reflective index modulation based on intelligent reflecting surface.

### BACKGROUND OF THE INVENTION

In the era of 6G wireless communication, more and more wireless devices are swarming into the modern cities, which poses a challenge to the spectrum efficiency of wireless communication network. Due to limited communication resources, the swarming of mass wireless devices results in a more crowded network, where the interferences among network users are becoming more serious, and the qualities of service (QOS) of the wireless communication, such as throughput and latency performance, are consequently degraded. Moreover, due to the rapid development of modern cities, buildings are becoming more and more dense. Hence, there are rarely line-of-sight (LOS) wireless communication links between base station (BS) and wireless devices. The inevitable channel fading will seriously degrade the communication efficiency of the network.

Intelligent reflecting surface (IRS) has been studied for many years by lots of scholars, and is considered as a promising technology in 6G wireless communication. An IRS is comprised of many reflecting elements, each reflecting element can reflect wireless signals with an adjustable phase shift. With the assistance of IRS, the abovementioned problem can be readily relieved. For instance, an IRS can be deployed on the wall of a building, which may eliminate blind spots and provide direct communication links between base station and wireless devices. IRS can also approximately adjust the reflecting phase shift to reshape the received signal at the receiver and reduce the interference caused by other wireless devices.

Apart from the assistance of IRS, index modulation is another approach to improve the spectrum efficiency. With the assistance of index modulation, additional information can be carried by activating different indices of the communication resources, such as antennas, time slots and carriers.

How to apply index modulation to IRS-assisted wireless communication system to further improve the spectrum efficiency is a key problem to solve in the prior art.

### SUMMARY OF THE INVENTION

The present invention aims to solve the problem in the prior art and provides a method for reflective index modulation based on intelligent reflecting surface, so as to apply index modulation to IRS-assisted wireless communication system to further improve the spectrum efficiency.

To achieve this objective, in accordance with the present invention, a method for reflective index modulation based on intelligent reflecting surface (hereinafter referred by IRS) is provided, comprising the following steps:

(1) creating an IRS-assisted wireless communication system, wherein the IRS-assisted wireless communication system comprises a transmitter, a receiver, an IRS and an IRS control unit, the transmitter is equipped with Nₜ antennas, the receiver is equipped with a single antenna due to the limitation of its hardware size, the IRS comprises Nₛ reflecting elements, and the Nₛ reflecting elements are divided into L groups, L≤log₂ Nₛ, each group has Nₛ/L reflecting elements, each reflecting element can modify the phase of received wireless signal and can be switched between active state and inactive state by the IRS control unit:

(2) transmitting data through reflective index modulation:
2.1) dividing the data to be transmitted in a transmission into two parts: a reflective domain data dᵣ and a phase-amplitude domain data d_{c}, then transmitting the reflective domain data dᵣ to the IRS control unit through a wired connection by the transmitter;
2.2) performing a reflective domain modulation by the IRS control unit: converting the received reflective domain data dᵣ into a reflective index j by using Gray mapping rule, where 1≤j≤L and j corresponds to the value of the reflective domain data dᵣ, then denoting the j-th IRS activating pattern as an indicator aⱼ=[a_{j,1}, a_{j,2}, . . . , a_{j,L}], where a_{j,l}=1, when 1≤l≤j, a_{j,l}=0, when j<l≤L, then activating or deactivating each group of reflecting elements according to the value of a_{j,l}: if a_{j,l}=1, then activating the l-th group of reflecting elements to turn them into active state, if a_{j,l}=0, then deactivating the group l-th of reflecting elements to turn them into inactive state;
2.3) performing a phase-amplitude domain modulation for the phase-amplitude domain data d_{c} by the transmitter to obtain a modulated baseband symbol bₘ, where m is a phase-amplitude modulation index and corresponds to the value of the phase-amplitude domain data d_{c}, then upconverting the modulated baseband symbol bₘ into a wireless signal and transmitting the wireless signal to the IRS through the Nₜ antennas of the transmitter;
2.4) receiving the wireless signals sent from the Nₜ antennas, modifying the phase of the received wireless signals and reflecting their received wireless signals to the receiver by the active reflecting elements of the IRS respectively;
2.5) receiving the wireless signals reflected by the active reflecting elements of the IRS through the receiver, converting the received wireless signals to baseband to obtain a received baseband symbol y_{m,j};
2.6) demodulating the baseband symbol y_{m,j} in phase-amplitude domain and reflective domain: finding a trial index m′ in the set of [1, 2, . . . , M] and a trial index j′ in the set of [1, 2, . . . , L] to make y_{m,j}−g_{j′}b_{m′}|² minimal and taking the trial index m′ as an estimated phase-amplitude modulation index m̅ and the trial index j′ as is an estimated reflective index j̅, where the demodulation process is expressed as:

$$( \overline{m} , \overline{J} ) = arg {{min}_{{m}^{′} ∈ [ 1 , 2 , ... , M ]}}_{{j}^{′} ∈ [ 1 , 2 , ... , L ]} ( {\vert {y}_{m , j} - {g}_{{j}^{′}} {b}_{{m}^{′}} \vert}^{2} )$$

where M is the modulation order of the phase-amplitude domain modulation, g_{j′} is the channel gain under the j′-th IRS activating pattern, which can be obtained by channel estimation, b_{m′} is the modulated baseband symbol of phase-amplitude modulation index m′;
2.7) recovering the value of the reflective domain data dᵣ according to the estimated reflective index j̅ and the value of the phase-amplitude domain data d_{c} according to the estimated phase-amplitude modulation index m̅ to recover the transmitted data.

The objective of the present invention is realized as follows:

In accordance with the present invention, a method for reflective index modulation based on intelligent reflecting surface is provided, in which an IRS control unit is added into wireless communication system, and the data to be transmitted in a transmission is divided into two parts: a reflective domain data dᵣ and a phase-amplitude domain data d_{c}, the reflective domain data d is transmitted through a wired connection to the IRS control unit to activate or deactivate each group of reflecting elements, the phase-amplitude domain data d_{c} is modulated through traditional phase-amplitude domain modulation and transmitted to the IRS, the reflected signals contain the information of the reflective domain data dᵣ, through the demodulating the baseband symbol y_{m,j}, an estimated phase-amplitude modulation index m and an estimated reflective index j̅ are obtained to recover the phase-amplitude domain data d_{c} and the value of the reflective domain data dᵣ respectively. The present invention transmits some data through activating or deactivating each group of reflecting elements by additional reflective index, more data can be transmitted in one transmission, therefore the spectrum efficiency is improved.

### BRIEF DESCRIPTION OF THE DRAWING

The above and other objectives, features and advantages of the present invention will be more apparent from the following detailed description taken in conjunction with the accompanying drawings, in which:

FIG. 1 is a flowchart of a method for reflective index modulation based on intelligent reflecting surface according to one embodiment of the present invention;

FIG. 2 is a diagram of a method for reflective index modulation based on intelligent reflecting surface according to one embodiment of the present invention;

FIG. 3 is a diagram of curves for validation of theoretical analysis of BER;

FIG. 4 is a diagram of curves for total BER comparison of RGNIM;

FIG. 5 is a diagram of curves for impact of imperfect channel estimation on total BER of the present invention.

### DETAILED DESCRIPTION OF THE PREFERRED EMBODIMENT

Hereinafter, preferred embodiments of the present invention will be described with reference to the accompanying drawings. It should be noted that the similar modules are designated by similar reference numerals although they are illustrated in different drawings. Also, in the following description, a detailed description of known functions and configurations incorporated herein will be omitted when it may obscure the subject matter of the present invention.

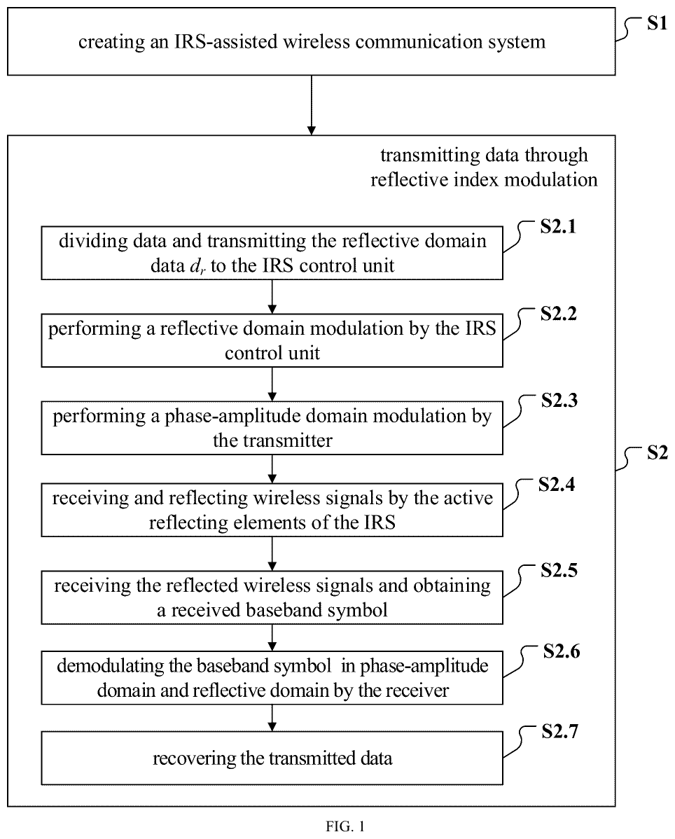

In one embodiment, as shown in FIG. 1, the present invention provides a method for reflective index modulation based on intelligent reflecting surface (hereinafter referred by IRS), which comprises the following steps:

### Step S1: Creating an IRS-Assisted Wireless Communication System

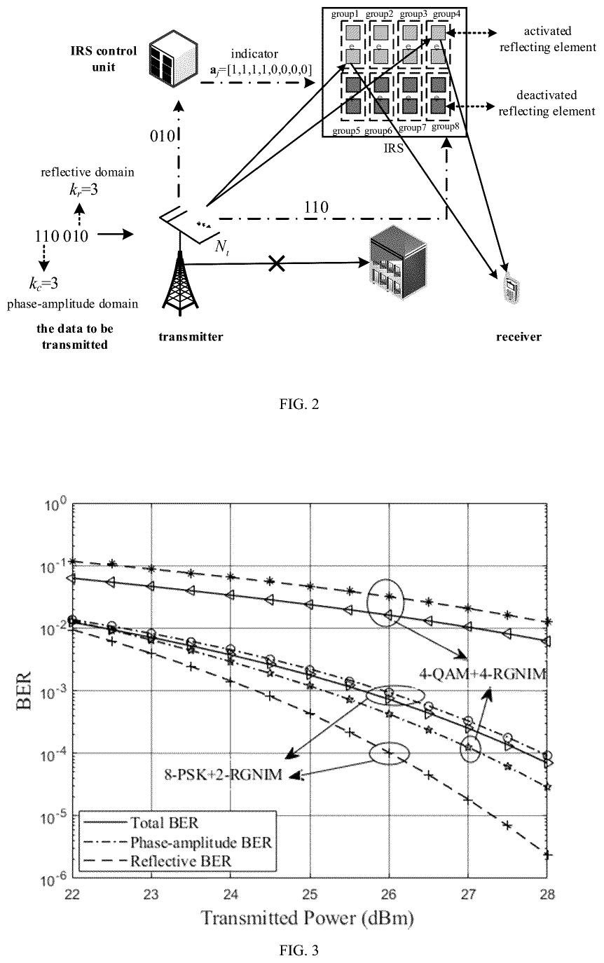

As shown in FIG. 2, the IRS-assisted wireless communication system is a multiple input single output (MISO) system, which comprises a transmitter, a receiver and an IRS. To realize a reflective domain modulation, the IRS control unit is added into the MISO system to create the IRS-assisted wireless communication system. Wherein the transmitter is equipped with Nₜ antennas, the receiver is equipped with a single antenna due to the limitation of its hardware size, the IRS comprises Nₛ reflecting elements, and the Nₛ reflecting elements are divided into L groups, L≤log₂ Nₛ, each group has Nₛ/L reflecting elements, each reflecting element can modify the phase of received wireless signal and can be switched between active state and inactive state by the IRS control unit. In the inactive state, the element would not reflect wireless signals. It's assumed that the direct communication link between the transmitter and the receiver does not exist, namely there is no line-of-sight (LOS) channel from the transmitter to the receiver due to the shelter of buildings or trees.

The block fading channels are assumed between the transmitter and the IRS as well as between the IRS and the receiver, which are not changed in one symbol. The channel state information (CSI) between the transmitter and the IRS is denoted as Hₜₛ∈ [symbol] ^{N}^{ₛ}^{×N}^{ₜ}, The CSI between the IRS and the receiver is denoted as hₛᵣ∈ [symbol] ^{1×N}^{ₛ}, [symbol] denotes the set of complex numbers. Assuming that CSI Hₜₛ is perfect and CSI hₛᵣ is imperfect, CSI hₛᵣ can be expressed as:

$${h}_{sr} = ρ {\hat{h}}_{sr} + \sqrt{1 - {ρ}^{2}} Δ h \qquad ( 1 )$$

where ρ is a channel estimation accuracy parameter, ĥₛᵣ represents the estimated CSI between the IRS and the receiver, Δh represents the channel estimation error, which is independent with the estimated CSI ĥₛᵣ. The elements in Δh are independent with each other and are Gaussian distributed having the variance of σₕ²=dₛᵣ^{-α}, where dₛᵣ is the distance between the IRS and the receiver and a is the pathloss exponent. Note that when ρ=1, hₛᵣ is perfectly estimated. The IRS phase shifter matrix is denoted as:

$$Φ = [ \begin{matrix}{β}_{1} {e}^{j {θ}_{1}} & 0 & … & 0 \\ 0 & {β}_{2} {e}^{j {θ}_{2}} & … & 0 \\ ⋮ & ⋮ & ⋱ & ⋮ \\ 0 & 0 & … & {β}_{{N}_{s}} {e}^{j {θ}_{{N}_{s}}}\end{matrix} ] \qquad ( 2 )$$

where βₗ, θₗ are the magnitude reflection coefficient and the phase shift of the l-th IRS reflecting element, respectively. To maximumly reflect the incoming signal, the magnitude reflection coefficients β₁=β₂= . . . =B_{N}_{ₛ}=1.

### Step S2: Transmitting Data Through Reflective Index Modulation

### Step S2.1: Dividing Data and Transmitting the Reflective Domain Data dᵣ to the IRS Control Unit

Dividing the data to be transmitted in a transmission into two parts: a reflective domain data dᵣ and a phase-amplitude domain data d_{c}, then transmitting the reflective domain data dᵣ to the IRS control unit through a wired connection by the transmitter.

### Step S2.2: Performing a Reflective Domain Modulation by the IRS Control Unit

Converting the received reflective domain data dᵣ into a reflective index j, where 1≤j≤L and j corresponds to the value of the reflective domain data dᵣ, then denoting the j-th IRS activating pattern as an indicator aⱼ=[a_{j,1}, a_{j,2}, . . . , a_{j,L}], where a_{j,l}=1, when 1≤|≤j, a_{j,l}=0, when j<l≥L, then activating or deactivating each group of reflecting elements according to the value of a_{j,l}: if a_{j,l}=1, then activating the l-th group of reflecting elements to turn them into active state, if a_{j,l}=0, then deactivating the l-th group of reflecting elements to turn them into inactive state.

The reflective domain modulation can be named as L-RGNIM (L-Reflective Group Number based Index Modulation). The IRS has L IRS activating patterns and the reflective domain data dᵣ in the reflective domain is carried by activating different groups of reflecting elements, the kᵣ=log₂ L bits can be transmitted in each transmission.

The conventional Gray mapping rule is used to map the received reflective domain data dᵣ into an indicator aⱼ.

TABLE 1

| received | | | activated groups |
|---|---|---|---|
| reflective | reflective | | of reflecting |
| domain data dᵣ | index j | indicator aⱼ | elements |
| 000 | 1 | [1, 0, 0, 0, 0, 0, 0, 0] | 1 |
| 001 | 2 | [1, 1, 0, 0, 0, 0, 0, 0] | 2 |
| 011 | 3 | [1, 1, 1, 0, 0, 0, 0, 0] | 3 |
| 010 | 4 | [1, 1, 1, 1, 0, 0, 0, 0] | 4 |
| 110 | 5 | [1, 1, 1, 1, 1, 0, 0, 0] | 5 |
| 111 | 6 | [1, 1, 1, 1, 1, 1, 0, 0] | 6 |
| 101 | 7 | [1, 1, 1, 1, 1, 1, 1, 0] | 7 |
| 100 | 8 | [1, 1, 1, 1, 1, 1, 1, 1] | 8 |

Table 1 shows a modulation principle of 8-RGNIM. When L=8, 3 bits can be transmitted in each transmission.

### Step S2.3: Performing a Phase-Amplitude Domain Modulation by the Transmitter

For the phase-amplitude domain data d_{c}, performing a phase-amplitude domain modulation to obtain a modulated baseband symbol bₘ, where m is a phase-amplitude modulation index and corresponds to the value of the phase-amplitude domain data d_{c}, then upconverting the modulated baseband symbol bₘ into a wireless signal and transmitting the wireless signal to the IRS through the Nₜ antennas of the transmitter.

The phase-amplitude domain modulation can be traditional modulation, such as M-QAM (Quadrature Amplitude Modulation) and M-PSK (Phase-Shift Keying). When the modulation order of the phase-amplitude domain modulation is M, the k_{c}=log₂ M bits can be transmitted in each transmission. When M=8, 3 bits can be transmitted in each transmission.

By jointly exploiting the reflective domain modulation and the phase-amplitude domain modulation, k=kᵣ+k_{c} bits can be transmitted in each transmission. In the embodiment, 6 bits can be transmitted in each transmission.

Without loss of generality, in the embodiment, M-QAM is adopted in the phase-amplitude domain modulation. The modulated baseband symbol bₘ, m=1, 2, . . . M can be expressed as bₘ=A_{l,m}+jA_{Q,m}, where A_{l,m} and A_{Q,m} are the in-phase and quadrature amplitude of bₘ, respectively. Given the average transmit power Pₛ, the amplitude set of A_{l,m} and A_{Q,m} is expressed as:

$$( {A}_{I , m} , {A}_{Q , m} ) ∈ \sqrt{\frac{3 {P}_{s}}{2 ( M - 1 )}} \{ 1 - \sqrt{M} , 3 - \sqrt{M} , ... , \sqrt{M} - 3 , \sqrt{M} - 1 \} \qquad ( 3 )$$

While the minimum Euclidean distance between the constellation point is:

$$ξ = 2 \sqrt{\frac{3 {P}_{s}}{2 ( M - 1 )}} \qquad ( 4 )$$

When the modulated baseband symbol bₘ is transmitted and the indicator aⱼ of the j-th IRS activating pattern works, the joint modulated symbol by considering M-QAM and L-RGNIM can be expressed as s_{m,j}. In the j-th IRS activating pattern, only the first j groups of reflecting elements are activated, the corresponding IRS phase shifter matrix Φⱼ can be expressed as:

$${Φ}_{j} = Φ [ \begin{matrix}{I}_{{jN}_{l} \times {jN}_{l}} & {0}_{{jN}_{l} \times ( L - j ) {N}_{l}} \\ {0}_{{jN}_{l} \times ( L - j ) {N}_{l}} & {0}_{( L - j ) {N}_{l} \times ( L - j ) {N}_{l}}\end{matrix} ] = Φ {A}_{j} \qquad ( 5 )$$

Where I_{jN}_{ₗ}_{×jN}_{ₗ} is the identity matrix having the size of jNₗ.

### Step S2.4: Receiving and Reflecting Wireless Signals by the Active Reflecting Elements of the IRS

Receiving the wireless signals sent from the Nₜ antennas, modifying the phase of the received wireless signals and reflecting their received wireless signals to the receiver by the active reflecting elements of the IRS respectively.

### Step S2.5: Receiving the Reflected Wireless Signals and Obtaining a Received b Baseband Symbol

Receiving the wireless signals reflected by the active reflecting elements of the IRS through the receiver, converting the received wireless signals to baseband to obtain a received baseband symbol y_{m,j}.

When the joint modulated symbol s_{m,j} is transmitted, the received baseband symbol y_{m,j} can be expressed as:

$$\begin{matrix}{y}_{m , j} = {h}_{sr} {Φ}_{j} {H}_{ts} {wb}_{m} + z \\ = ρ {\hat{h}}_{sr} {Φ}_{j} {H}_{ts} {wb}_{m} + \sqrt{1 - {ρ}^{2}} Δ h {Φ}_{j} {H}_{ts} {wb}_{m} + z \\ = ρ {g}_{j} {b}_{m} + \sqrt{1 - {ρ}^{2}} Δ {hg}_{j} {b}_{m} + z\end{matrix} \qquad ( 6 )$$

where w is the beamforming vector at the transmitter, z accounts for the additive white Gaussian noise (AWGN) as well as the interference at the receive antenna having the variance of σₐ², σₐ² is a noise variance, gⱼ=ĥₛᵣΦⱼHₜₛw and gⱼ=ΦHₜₛw.

Step S2.6: Demodulating the Baseband Symbol y_{m,j} in Phase-Amplitude Domain and Reflective Domain by the Receiver

In order to recover the joint modulated symbol s_{m,j}, a maximum likelihood (ML) detector is adopted for jointly demodulating the data information in both phase-amplitude domain and the reflective domain: finding a trial index m′ in the set of [1, 2, . . . , M] and a trial index j′ in the set of [1, 2, . . . , L] to make |y_{m,j}−g_{j′}b_{m′}|² minimal and taking the trial index m′ as an estimated phase-amplitude modulation index m̅ and the trial index j′ as is an estimated reflective index j̅, where the demodulation process is expressed as:

$$( \overline{m} , \overline{J} ) = arg {{min}_{{m}^{′} ∈ [ 1 , 2 , ... , M ]}}_{{j}^{′} ∈ [ 1 , 2 , ... , L ]} ( {\vert {y}_{m , j} - {g}_{{j}^{′}} {b}_{{m}^{′}} \vert}^{2} ) \qquad ( 7 )$$

Where M is the modulation order of the phase-amplitude domain modulation, g_{j′} is the channel gain under the j′-th IRS activating pattern, which can be obtained by channel estimation, b_{m′} is the modulated baseband symbol of phase-amplitude modulation index m′.

### Step S2.7: Recovering the Transmitted Data

Recovering the value of the reflective domain data dᵣ according to the estimated reflective index j̅ and the value of the value of the phase-amplitude domain data dᵣ according to the estimated phase-amplitude modulation index m̅ to recover the transmitted data.

### Performance Analysis

In this section, we aim to analyze the bit error ratio (BER) performance of the RGNIM assisted system by adopting the ML detection approach.

### A. Pairwise Error Probability

Firstly, we define a pairwise error probability (PEP) between two joint modulated symbols s_{m,j} and s_{n,i} (m≠n, i≠j) as τ(s_{m,j}→s_{n,i}), which is the probability that the Euclidean distance between the baseband symbol y_{m,j} and the joint modulated symbol s_{m,j}, is larger than that between the baseband symbol y_{m,j} and the joint modulated symbol s_{n,i}, when the joint modulated symbol s_{m,j} is transmitted, the pairwise error probability τ(s_{m,j}→s_{n,i}) can be expressed as:

$$τ ( {s}_{m , j} \to {s}_{n , i} ) = Pr [ {\vert {y}_{m , j} - {g}_{j} {b}_{m} \vert}^{2} > {\vert {y}_{m , j} - {g}_{i} {b}_{n} \vert}^{2} ] = Pr [ {\vert \sqrt{1 - {ρ}^{2}} Δ {hg}_{j} {b}_{m} + z + ( ρ - 1 ) {g}_{j} {b}_{m} \vert}^{2} > {\vert \sqrt{1 - {ρ}^{2}} Δ {hg}_{j} {b}_{m} + z + ρ {g}_{j} {b}_{m} - {g}_{i} {b}_{n} \vert}^{2} ] \qquad ( 8 )$$

Where Pr is the abbreviation of probability. Since Δh is a Gaussian distributed vector independent with the noise z,\sqrt{1−ρ²}Δhgⱼbₘ+z is also Gaussian distributed. Denoting Δ_{m,j}=\sqrt{1−ρ²}Δhgⱼbₘ+z, then Δ_{m,j}˜ [symbol] (0,σ_{m,j}²), where σ_{m,j}²=(1−ρ²)∥gⱼ∥²|bₘ|²σₕ²+σₐ².

The pairwise error probability τ(s_{m,j}=>s_{n,i}) can be further expressed as:

$$τ ( {s}_{m , j} \to {s}_{n , i} ) = Pr [ {\vert {λ}_{m , j} + ( ρ - 1 ) {g}_{j} {b}_{m} \vert}^{2} > {\vert {λ}_{m , j} + ρ {g}_{j} {b}_{m} - {g}_{i} {b}_{n} \vert}^{2} ] = Pr [ {\vert 2 ℛ ( {{λ}_{m , j} ( {g}_{i} {b}_{n} - {g}_{j} {b}_{m} )}^{*} ) \vert}^{2} > {\vert ρ {g}_{j} {b}_{m} - {g}_{i} {b}_{n} \vert}^{2} - {\vert ( ρ - 1 ) {g}_{j} {b}_{m} \vert}^{2} ] \qquad ( 9 )$$

Where [symbol] (x) represents the real part of the complex number x. According to the statistical characteristic of λ_{m,j}, the left-hand-side (LHS) of the above equation obeys a Gaussian distribution of [symbol] (0,|gⱼbₘ−gᵢbₙ|² σ_{m,j}²/2), the above equation can be further expressed as:

$$τ ( {s}_{m , j} \to {s}_{n , i} ) = Q ( \frac{{\vert ρ {g}_{j} {b}_{m} - {g}_{i} {b}_{n} \vert}^{2} - {\vert ( ρ - 1 ) {g}_{j} {b}_{m} \vert}^{2}}{\vert {g}_{j} {b}_{m} - {g}_{i} {b}_{n} \vert \sqrt{2 {σ}_{m , j}^{2}}} ) \qquad ( 10 )$$

$$where Q ( x ) = {\int }_{x}^{+ ∞} \frac{1}{\sqrt{2 π}} {e}^{\frac{{t}^{2}}{2}} dt .$$

Similarly, the PEP τ(s_{m,j}→s_{m,i}) between the joint modulated symbols s_{m,j} and s_{m,i} and the PEP τ(s_{m,j}→s_{m,i}) between the joint modulated symbols s_{m,j} and s_{n,j} are derived as:

$$τ ( {s}_{m , j} \to {s}_{m , i} ) = Q ( \frac{\vert {b}_{m} \vert ( {\vert ρ {g}_{j} - {g}_{i} \vert}^{2} - {\vert ( ρ - 1 ) {g}_{j} \vert}^{2} )}{\vert {g}_{j} - {g}_{i} \vert \sqrt{2 {σ}_{m , j}^{2}}} ) \qquad ( 11 )$$

$$τ ( {s}_{m , j} \to {s}_{n , j} ) = Q ( \frac{\vert {g}_{j} \vert ( {\vert ρ {b}_{m} - {b}_{n} \vert}^{2} - {\vert ( ρ - 1 ) {b}_{m} \vert}^{2} )}{\vert {b}_{m} - {b}_{n} \vert \sqrt{2 {σ}_{m , j}^{2}}} ) \qquad ( 12 )$$

### B. BER Performance

Denoting the alphabetical set of the joint modulated symbols as [symbol] ={s_{m,j}|m∈[1, 2, . . . , M], j € [1, 2, . . . , L] }, the decoding BER at the receiver is expressed as:

$$ε = \frac{1}{kML} {\sum }_{{s}_{m , j} ∈ 𝒮} {\sum }_{{{s}_{n , i} ∈ 𝒮}_{{s}_{m , j} \neq {s}_{n , i}}} d ( {s}_{m , j} , {s}_{n , i} ) Pr ( {s}_{m , j} \to {s}_{n , i} ) \qquad ( 13 )$$

Where k=kᵣ+k_{c}, namely k is the number of the total bits transmitted in reflective domain and phase-amplitude domain in each transmission, d(s_{m,j}, s_{n,i}) represents the Hamming distance between the information bits carried by two joint modulated symbols s_{m,j} and s_{n,i}, Pr(s_{m,j}→s_{n,i}) represents the probability that the transmitted joint modulated symbol s_{m,j} is mis-demodulated as s_{n,i}. When the signal noise ratio (SNR) is not very low, the mis-demodulation probability Pr(s_{m,j}→s_{n,i}) can be approximated as the PEP τ(s_{m,j}→s_{n,i}). Therefore, the BER can be further approximated as:

$$ε = \frac{1}{k \vert 𝒮 \vert} {\sum }_{{s}_{m , j} ∈ 𝒮} {\sum }_{{{s}_{n , i} ∈ 𝒮}_{{s}_{m , j} \neq {s}_{n , i}}} d ( {s}_{m , j} , {s}_{n , i} ) τ ( {s}_{m , j} \to {s}_{n , i} ) \qquad ( 14 )$$

The Hamming distance d(s_{m,j}, s_{n,i}) can be decomposed as d(s_{m,j}, s_{n,i})=d_{c}(s_{m,j}, s_{n,i})+dᵣ(s_{m,j}, s_{n,i}), where d_{c}(s_{m,j}, s_{n,i}) and dᵣ(s_{m,j}, s_{n,i}) are the Hamming distance between the information bits carried by s_{m,j} and s_{n,i} in phase-amplitude domain and reflective domain, respectively. Therefore, by decomposing the joint modulation scheme into two domains, we are able to obtain the BER in conventional phase-amplitude domain and the reflective domain as:

$${ε}_{c} = \frac{1}{{k}_{c} \vert 𝒮 \vert} {\sum }_{{s}_{m , j} ∈ 𝒮} {\sum }_{{{s}_{n , i} ∈ 𝒮}_{{s}_{m , j} \neq {s}_{n , i}}} {d}_{c} ( {s}_{m , j} , {s}_{n , i} ) τ ( {s}_{m , j} \to {s}_{n , i} ) \qquad ( 15 )$$

$${ε}_{r} = \frac{1}{{k}_{r} \vert 𝒮 \vert} {\sum }_{{s}_{m , j} ∈ 𝒮} {\sum }_{{{s}_{n , i} ∈ 𝒮}_{{s}_{m , j} \neq {s}_{n , i}}} {d}_{r} ( {s}_{m , j} , {s}_{n , i} ) τ ( {s}_{m , j} \to {s}_{n , i} ) \qquad ( 16 )$$

### Optimizing the Phase Shifts of Reflecting Elements

In the IRS transmission system with traditional non-index modulation, the phase shifts of reflecting elements can be optimized by performing a joint phase compensation on two-hop channel to improve the QOS of the receiver and reduce the BER. However, In the IRS transmission system based on reflective index modulation, different state (active state or inactive state) of reflecting elements will affect the quality of the received signal, therefore, the BER of the receiver is not only related to the strength of the received signal, but also to the influence of reflective index on constellation. In consideration of different reflective index's corresponding state of reflecting elements, we hope to improve the communication performance of the IRS transmission system based on reflective index modulation through minimizing the bit error ratio (BER) shown in equation (14). Under the circumstance of high signal-to-noise ratio and accurate channel estimation (channel estimation accuracy parameter ρ approaches to 1), the BER shown in equation (14) can be further approximated as:

$$ε = \frac{1}{k \vert 𝒮 \vert} {\sum }_{{s}_{m , j} ∈ 𝒮} {\sum }_{{{s}_{n , i} ∈ 𝒮}_{{s}_{m , j} \neq {s}_{n , i}}} d ( {s}_{m , j} , {s}_{n , i} ) Q ( \frac{{\vert {g}_{j} {b}_{m} - {g}_{i} {b}_{n} \vert}^{2}}{\sqrt{2 {σ}_{m , j}^{2}}} ) \qquad ( 17 )$$

The phase shifts of reflecting elements exist only in the above Q function, and the value of Q function decreases with the increase of variable value, therefore, minimizing the BER shown in equation (15) is equivalent to maximizing the minimal value of |gⱼbₘ−gᵢbₙ|, namely the Euclidean distance of two joint modulated symbols s_{m,j} and s_{n,i} at the receiver. The square of the Euclidean distance of two joint modulated symbols s_{m,j} and s_{n,i} at the receiver can be expressed as:

$$\begin{matrix}𝒟 ( {s}_{m , j} , {s}_{n , i} ) = {\vert {g}_{j} {b}_{m} - {g}_{i} {b}_{n} \vert}^{2} \\ = {\vert {\hat{h}}_{sr} {Φ}_{j} {H}_{ts} {wb}_{m} - {\hat{h}}_{sr} {Φ}_{i} {H}_{ts} {wb}_{n} \vert}^{2} \\ = {\vert {uA}_{j} ξ {b}_{m} - {uA}_{i} ξ {b}_{n} \vert}^{2} \\ = {uR}_{m , n , j , i} {u}^{H}\end{matrix} \qquad ( 18 )$$

Where u^{H}=diag(Φ)=(u₁, u₂, . . . , u_{N}_{ₛ}), uₗ=e^{jθ}^{ₗ}, l=1, 2, . . . , Nₛ, diag(Φ) represents turning the IRS phase shifter matrix Φ into a vector, R_{m,n,j,i}=(Δⱼξbₘ−Aᵢξbₙ)(Aⱼξbₘ−Aᵢξbₙ)^{H}, ξ=diag(ĥₛᵣ)Hₜₛw, diag(ĥₛᵣ) represents turning the vector ĥₛᵣ into a diagonal matrix. Therefore, the optimization problem of the phase shifts of reflecting elements can be established as:

$${max}_{u} {min}_{{s}_{m , j} \neq {s}_{n , i}} {uR}_{m , n , j , i} {u}^{H} \qquad ( 19 )$$

$$s . t . \vert {u}_{l} \vert = 1 , l = 1 , 2 , ... , {N}_{s}$$

From the optimization problem of equation (19), we can see that the phase shift of reflecting element is related not only to the channel state information, but also to the joint modulated scheme. When the channels or the joint modulated scheme changes, the optimal u, namely the phase shifts of reflecting elements will change accordingly. Assuming that the channels are unchanged in a modulated symbol, we can solve the optimization problem of equation (19) in the time of the modulated symbol.

To solve the optimization problem of equation (19), we introduce a variable t and let u^{H}u=U, then rank(U)=1 and UR_{m,n,j,i}u^{H}=tr(R_{m,n,j,i}u^{H}u)=tr(R_{m,n,j,i}U), the optimization problem of equation (19) can be equivalent to:

$${max}_{t , u} t \qquad ( 20 )$$

$$s . t . tr ( {R}_{m , n , j , i} U ) \geq t , \text{} ∀ {s}_{m , j} , \text{} {s}_{n , i} ∈ 𝒮 , \text{} {s}_{m , j} \neq {s}_{n , i} , \text{} U \geq 0 , \text{} rank ( U ) = 1 and {U}_{l , l} = 1 , l = 1 , 2 , ... , {N}_{s}$$

Where U_{l,l} represents the element of the l-th row and l-th column of the matrix U.

However, the rank one constraint rank(U)=1 is non-convex, the optimization problem of equation (20) is still a non-convex problem. To solve the optimization problem of equation (20), a scale is needed, namely the rank one constraint rank(U)=1 needed to be discarded. Then a solution that satisfied with the constraints in the optimization problem of equation (20) can be founded by searching t with bisection algorithm, and the upper bound of the optimal value can be obtained. The process of optimizing can be expressed as:

$$Find U \qquad ( 21 )$$

$$s . t . tr ( {R}_{m , n , j , i} U ) \geq t , \text{} ∀ {s}_{m , j} , \text{} {s}_{n , i} ∈ \text{} 𝒮 , \text{} {s}_{m , j} \neq {s}_{n , i} , \text{} U \geq 0 , \text{} and {U}_{l , l} = 1 , \text{} l = 1 , \text{} 2 , ... , {N}_{s}$$

When variable t is given, the optimization problem of equation (21) is a convex positive semidefinite program and can be solved by a traditional optimizer. In addition, when the given variable t can make optimization problem of equation (21) solvable, it shows that t≤t*, when the given variable t can't make optimization problem of equation (21) solvable, it shows that t>t*. Through continuously searching t with bisection algorithm, the optimal value t* and the optimal value U* of the optimization problem of equation (20) can be obtained. When the optimal value U* satisfies with rank(U*)=1, the optimal value t* and the optimal value U* are optimal solution of the optimization problem of equation (20). When rank(U*)>1, the optimal value t* is the lower bound of the optimal value of equation (20).

To recover an optimal vector u*, Gaussian randomization can be used to obtain an approximate vector u. More specifically, the Gaussian randomization comprises the following steps: performing an eigenvalue decomposition U*=VΣV^{H} on the optimal value U*, where V is a unitary matrix composed of eigenvectors of the optimal value U*, Σ is a diagonal matrix composed of eigenvectors of the optimal value U*, then letting u*=VΣ^{1/2}r, where r is a random vector in which each element obeys Gaussian distribution.

After obtaining the approximate vector u*, we can obtain optimized phase shifts θₗ*, l=1, 2, . . . , Nₛ of reflecting elements according to the following equation:

$$diag ( {u}^{* H} ) = ( {u}_{1}^{*} , {u}_{2}^{*} , ... , {u}_{{N}_{s}}^{*} ) \qquad ( 22 )$$

$$where {u}_{l}^{*} = {e}^{j {θ}_{l}^{*}} .$$

### Simulation

### A. Parameter Setting

In this section, the BER performance of the present invention is evaluated by the MATLAB aided simulation. The transmitter is equipped with Nₜ=4 antennas, while the number of the IRS reflecting elements is set to Nₛ=64. Each element H_{i,j}∈Hₜₛ satisfies H_{i,j}˜ [symbol] (0,dₜₛ^{-α}), and hᵢ∈hₛᵣ satisfies hᵢ˜ [symbol] (0, dₛᵣ^{-α}), where dₜₛ and dₛᵣ are the distance between the transmitter and the IRS and the distance between the IRS and the receiver, respectively. The power of the additive white Gaussian noise (AWGN) and the interference is set to σₐ²=−50 dBm. The transmit beamforming vector is set as

$$w = \frac{1}{\sqrt{{N}_{t}}} * [ 1 , 1 , ... , 1 ] ,$$

while the magnitude reflection coefficient of the IRS is set to β₁=β₂= . . . =B_{N}_{ₛ}=1. In order to ensure that multiple reflected wireless signal from the IRS can be superimposed positively, the phase shift θᵢ is set to:

$${θ}_{i} = - ∠ ( {\sum }_{j = 1}^{{N}_{t}} {H}_{ts , i , j} {w}_{i} ) - ∠ {\hat{h}}_{sr , i} \qquad ( 23 )$$

Where H_{ts,i,j} represents the element at the i-th row and the j-th column in Hₜₛ, ĥ_{sr,i} represents the element at the i-th column in ĥₛᵣ, where as ∠x denotes the phase of the complex number x. Without specific statement, the channel estimation accuracy parameter is set to ρ=0.99.

### B. Numerical Results

The theoretical BER analysis of the present invention is validated in FIG. 3, the lines are theoretical results and the dots are simulation results, where the 4-QAM and 8-PSK conventional modulation schemes are conceived by jointly considering 4-RGNIM and 2-RGNIM modulation schemes, respectively. The data rate is k=4 bit/channel use. The simulation results are obtained by the Monte Carlo based simulation, where there are totally 10⁸ information bits transmitted to the receiver. Observe from FIG. 3 that the theoretical results of the total BER E, the phase-amplitude BER ε_{c} and the reflective BER εᵣ match well with the simulation results. Therefore, in order to reduce the complexity, the theoretical results are used to evaluate the BER performance of RGNIM assisted system in the latter simulations. Moreover, the BER of the 8-PSK+2-RGNIM scheme outperforms that of the 4-QAM+4-RGNIM scheme. Especially, a lower order of the phase-amplitude modulation scheme results in a lower phase-amplitude BER, while a lower order of the reflective modulation scheme results in a lower reflective BER.

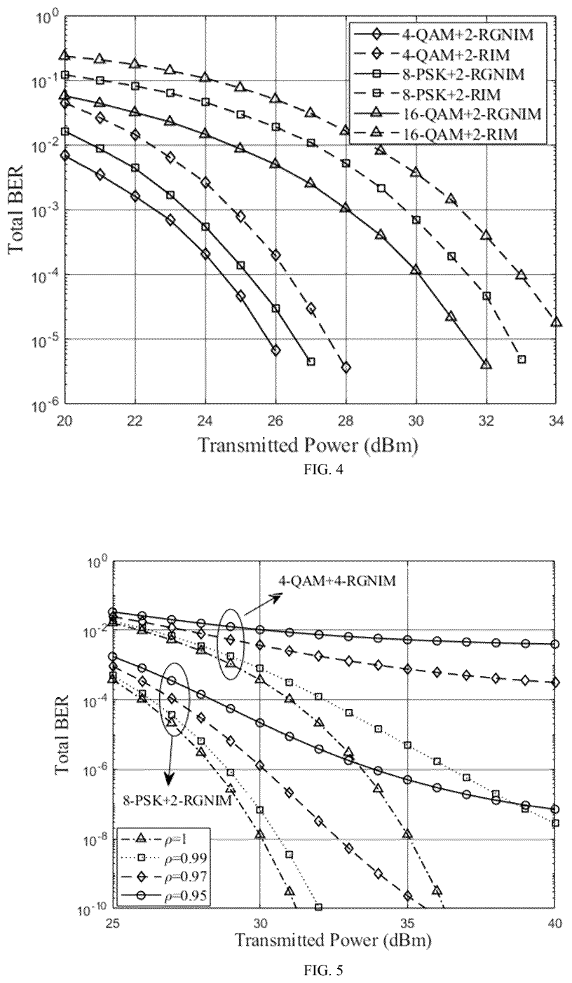

FIG. 4 compares the total BER performance between our RGNIM scheme and the RIM scheme, in which different (L−1) groups of IRS elements are activated for modulating various reflective information. The 4-QAM, 8-PSK and 16-QAM conventional modulation schemes are conceived by jointly considering 2-RGNIM modulation schemes. Observe from FIG. 4 that our RGNIM outperforms the RIM. Moreover, a higher data rate results in a higher BER, since the Euclidean distance between two adjacent joint modulated symbols are smaller.

FIG. 5 evaluates the impact of the imperfect channel estimation on the total BER of the RGNIM assisted system, where the 4-QAM+4-RGNIM and the 8-PSK+2-RGNIM joint modulation schemes are conceived. Observe from FIG. 5 that a smaller channel estimation parameter p results in a higher total BER for both the schemes. This is because that when channel estimation parameter p becomes smaller, the channel estimation error becomes larger, which has more influence on the joint demodulation and then reduces the correctness. When we continually increase the transmit power, the total BER with imperfect CSI gradually becomes flat, since the channel estimation error dominates interference and the noise. Note that when ρ=1, the CSI is perfectly estimated, which results in the lowest BER.

While illustrative embodiments of the invention have been described above, it is, of course, understand that various modifications will be apparent to those of ordinary skill in the art. Such modifications are within the spirit and scope of the invention, which is limited and defined only by the appended claims.

What is claimed is:

1. A method for reflective index modulation based on intelligent reflecting surface (hereinafter referred by IRS) is provided, comprising the following steps:
(1) creating an IRS-assisted wireless communication system, wherein the IRS-assisted wireless communication system comprises a transmitter, a receiver, an IRS and an IRS control unit, the transmitter is equipped with Nₜ antennas, the receiver is equipped with a single antenna due to the limitation of its hardware size, the IRS comprises Nₛ reflecting elements, and the Nₛ reflecting elements are divided into L groups, L≤log₂ Nₛ, each group has Nₛ/L reflecting elements, each reflecting element can modify the phase of received wireless signal and can be switched between active state and inactive state by the IRS control unit:
(2) transmitting data through reflective index modulation:
2.1) dividing the data to be transmitted in a transmission into two parts: a reflective domain data dᵣ and a phase-amplitude domain data d_{c}, then transmitting the reflective domain data dᵣ to the IRS control unit through a wired connection by the transmitter;
2.2) performing a reflective domain modulation by the IRS control unit: converting the received reflective domain data dᵣ into a reflective index j, where 1≤j≤L and j corresponds to the value of the reflective domain data dᵣ, then denoting the j-th IRS activating pattern as an indicator aⱼ=[a_{j,1}, a_{j,2}, . . . , a_{j,L}], where a_{j,l}=1, when 1≤l≤j, a_{j,l}=0, when j<l≤L, then activating or deactivating each group of reflecting elements according to the value of a_{j,l}: if a_{j,l}=1, then activating the l-th group of reflecting elements to turn them into active state, if a_{j,l}=0, then deactivating the l-th group of reflecting elements to turn them into inactive state;
2.3) performing a phase-amplitude domain modulation for the phase-amplitude domain data d_{c} by the transmitter to obtain a modulated baseband symbol bₘ, where m is a phase-amplitude modulation index and corresponds to the value of the phase-amplitude domain data d_{c}, then upconverting the modulated baseband symbol bₘ into a wireless signal and transmitting the wireless signal to the IRS through the Nₜ antennas of the transmitter;
2.4) receiving the wireless signals sent from the Nₜ antennas, modifying the phase of the received wireless signals and reflecting their received wireless signals to the receiver by the active reflecting elements of the IRS respectively;
2.5) receiving the wireless signals reflected by the active reflecting elements of the IRS through the receiver, converting the received wireless signals to baseband to obtain a received baseband symbol y_{m,j};
2.6) demodulating the baseband symbol y_{m,j} in phase-amplitude domain and reflective domain: finding a trial index m′ in the set of [1, 2, . . . , M] and a trial index j′ in the set of [1, 2, . . . , L] to make |y_{m,j}−g_{j′}b_{m′}|² minimal and taking the trial index m′ as an estimated phase-amplitude modulation index m̅ and the trial index j′ as is an estimated reflective index j̅, where the demodulation process is expressed as:
$$( \overline{m} , \overline{J} ) = arg {{min}_{{m}^{′} ∈ [ 1 , 2 , ... , M ]}}_{{j}^{′} ∈ [ 1 , 2 , ... , L ]} ( {\vert {y}_{m , j} - {g}_{{j}^{′}} {b}_{{m}^{′}} \vert}^{2} )$$
where M is the modulation order of the phase-amplitude domain modulation, g_{j′} is the channel gain under the j′-th IRS activating pattern, which can be obtained by channel estimation, b_{m′} is the modulated baseband symbol of phase-amplitude modulation index m′;
2.7) recovering the value of the reflective domain data dᵣ according to the estimated reflective index j̅ and the value of the phase-amplitude domain data d_{c} according to the estimated phase-amplitude modulation index m to recover the transmitted data.

2. A method for reflective index modulation based on intelligent reflecting surface according to claim 1, wherein the phase shifts of reflecting elements are optimized according to following steps:
3.1) letting u^{H}=diag(Φ)=(u₁, u₂, . . . , u_{N}_{ₛ}) and u^{H}u=U, where u=βₗe^{jθl}, l=1, 2, . . . , Nₛ, diag(Φ) represents turning the IRS phase shifter matrix Φ into a vector;
3.2) letting R_{m,n,j,i}=(Aⱼξbₘ−Aᵢξbₙ)(Aⱼξbₘ−Aᵢξbₙ)^{H}, ξ=diag(ĥₛᵣ)Hₜₛ w, where:
$${A}_{j} = [ \begin{matrix}{I}_{{jN}_{l} \times {jN}_{l}} & {0}_{{jN}_{l} \times ( L - j ) {N}_{l}} \\ {0}_{{jN}_{l} \times ( L - j ) {N}_{l}} & {0}_{( L - j ) {N}_{l} \times ( L - j ) {N}_{l}}\end{matrix} ] {A}_{i} = [ \begin{matrix}{I}_{{iN}_{l} \times {iN}_{l}} & {0}_{{iN}_{l} \times ( L - i ) {N}_{l}} \\ {0}_{{iN}_{l} \times ( L - i ) {N}_{l}} & {0}_{( L - i ) {N}_{l} \times ( L - i ) {N}_{l}}\end{matrix} ]$$
ĥₛᵣ represents the estimated CSI between the IRS and the receiver, diag(ĥₛᵣ) represents turning the vector ĥₛᵣ into a diagonal matrix, Hₜₛ is the channel state information (CSI) between the transmitter and the IRS, w is the beamforming vector at the transmitter;
3.3) solving optimization problem:
Find U
s.t.tr(R_{m,n,j,i}U)≥t, ∀s_{m,j}, s_{n,i}∈ [symbol] , s_{m,j}≠s_{n,i}, U≥0, and U_{l,l}=1, l=1, 2, . . . , Nₛ
where t is an introduced variable, s_{m,j} is a joint modulated symbol of the modulated baseband symbol bₘ with the j-th IRS activating pattern, s_{n,i} is a joint modulated symbol of the modulated baseband symbol bₙ with the i-th IRS activating pattern, [symbol] ={s_{m,j}|m∈[1, 2, . . . , M], j∈[1, 2, . . . , L]}, U≥0 represents U is positive semidefinite matrix, U_{l,l} represents the element of the l-th row and l-th column of matrix U, through continuously searching t with bisection algorithm, the optimal value U* of the optimization problem is obtained;
3.3) recovering an optimal vector u*: performing an eigenvalue decomposition U*=VΣV^{H} on the optimal value U*, where Vis a unitary matrix composed of eigenvectors of the optimal value U*, Σ is a diagonal matrix composed of eigenvectors of the optimal value U*, then letting u*=VΣ^{1/2}r, where r is a random vector in which each element obeys Gaussian distribution;
3.4) obtaining optimized phase shifts θₗ*, l=1, 2, . . . , Nₛ of reflecting elements according to the following equation:
diag(u*^{H})=(u¹*,u²*, . . . ,u_{N}_{ₛ}*)
where uₗ*=e^{jθ*}^{ₗ}.
